(19) United States
(12) Patent Application Publication
(10) Pub. No.: US 2003/0044500 A1
(43) Pub. Date: Mar. 6, 2003

(54) DEVICE FOR REMOVING UNWANTED VOLATILE COMPOUNDS FROM BEER WORT

(76) Inventor: DIRK SELDESLACHTS, WINKSELE (BE)

Correspondence Address: BACHMAN & LAPOINTE, 900 CHAPEL STREET, SUITE 1201, NEW HAVEN, CT, 065102802

(21) Appl. No.: 09/051,565

(22) PCT Filed: Oct. 25, 1996
(86) PCT No.: PCT/IB96/01155

(30) Foreign Application Priority Data
Oct. 27, 1995 (FR) 95 12735

(51) Int. Cl. A23L 1/015

(52) U.S. Cl. 426/492; 426/486; 426/487; 426/488; 99/278

(57) ABSTRACT

A device for eliminating unwanted volatile components from beer wort comprises a column (1) comprising:

means (2) for uniformly distributing the beer wort inside said column (1) in a first direction,

means (10) for uniformly distributing a current of inert gas or steam inside the column (1) in a second direction, preferably opposite to said first direction, and

means for increasing the surface area of contact of said wort inside said column (1) with said current of inert gas or steam.

The invention concerns a new device for eliminating unwanted volatile components from beer wort.

It also relates to a method of eliminating unwanted volatile components using the device of the present invention.

In the brewing industry, the boiling of the wort is a complex operation conditioning not only the organoleptic qualities of the beer, but also its stability, in particular the quality and the stability of the head. Good control over this stage of manufacture is therefore necessary, both to obtain a beer that is of satisfactory quality, but also because this stage of manufacture consumes most of the energy used in the manufacture of beer.

One of the many operations involved in boiling the wort is eliminating unwanted volatile aromatic components from the wort, in particular sulphur-containing substances such as DMS (dimethyl sulphide) and essential oils from the malt and the hops.

Conventional methods of boiling the wort generally eliminate the unwanted aromatic components by vigorously evaporating the wort, inevitably leading to the use of a large amount of energy.

Research has therefore been conducted into reducing or recovering the energy used to evaporate the wort. The proposed solutions have until now been able to recover only some of the energy consumed. Moreover, in most cases the energy recovery methods require modification of the production site and this leads to high investments.

To avoid these problems attempts have been made to develop different methods of boiling the wort, using little evaporation and therefore a low amount of energy.

One such proposed method heats the wort, without notable evaporation, to form a hot precipitate. This hot precipitate is separated out at the same time as certain unwanted solid components during the clarification of the wort.

In this method the unwanted volatile components are eliminated from the wort by means of intensive contact between the heated wort and a current of inert gas or steam.

During this contact, the unwanted volatile components are transferred from the wort to the current of inert gas or steam and can then be extracted.

Although this method significantly reduces the amount of energy required, it is nevertheless subject to the problem that the desorption columns used to transfer the volatile components from the wort to the gas phase are of only limited efficiency.

A main aim of the invention is to solve this problem by proposing an effective new desorption device offering higher efficiency.

WO 95/26395 describes a method of continuous boiling of beer wort. This method comprises the following steps: heating the wort to between 80 and 110° C., introducing the heated wort into an ideal flow reactor, preferably a rotary disc type holding column, and treating the wort leaving this reactor with a contraflow of steam in a degassing or stripping column.

The stripping column may be a plate type column including at least five plates or a column filled with filler bodies, the filler bodies extending to a height of at least two metres.

In the example described, which corresponds to equipment on a pilot plant scale, the wort heated to 103° C. is introduced at a flowrate of 1 200 l/h into a 600 l rotary dish type reactor, in which it therefore remains or 30 minutes on average. It is stated that S-methylmethionine (SMM) is satisfactorily converted into dimethyl sulphide (DMS).

The wort is then fed to the top part of a plate type column equipped with 12 plates and down tubes. The liquid load of the column is approximately 20 litres. Saturated steam is fed into the bottom part of the column in a proportion of 5%.

The stated proportions of the DMS in the wort are 195 μg/l after the reactor and less than 10 μg/l after stripping, for a final DMS content of the beer of 40 μg/l.

It would therefore appear that almost 95% of the DMS entering the stripping column is evaporated by the steam, which is an excellent result.

The problem is to transpose these experiments to an industrial scale. To be more precise, if a column with 12 plates is required for a flowrate of 1 200 l/hour, how big would a column have to be for a flowrate of about 40 m³/hour to 60 m³/hour, common in the brewing industry.

Furthermore, the above document does not give any indication of the problems inherent to treating the wort in a stripping column:

a) the person skilled in the art is familiar with the tendency of the wort to foaming, the foam being caused either by bubbling of the steam in the wort or simply by the boiling of the wort.

b) the person skilled in the art knows that the wort has a relative high viscosity, does not flow like a liquid and constitutes an unstable suspension. Any material that may settle out must be regularly and effectively cleaned out, failing which it may impede subsequent operation of the column, which becomes partially blocked, and constitute impurities capable of significantly deteriorating the organoleptic qualities of the beer produced under these conditions.

It is clear that the column with 12 plates described in the aforementioned document is not suitable for stripping beer wort on an industrial scale with acceptable economic conditions in terms of investment and operating, cleaning and maintenance costs.

A stripping column filled with filler bodies is mentioned as being usable in theory, but the aforementioned document does not give any other information on this subject apart from the minimal height of 2 metres required for the volume filled with the filler bodies.

The problem to which the invention is addressed is therefore that of remedying the drawbacks of the prior art devices and proposing a stripping column capable of economic and reliable degassing of beer wort at an industrial scale flowrate of the wort, for example a few tens of m³/h, this stripping having a predetermined efficiency sufficient to eliminate virtually any vigorous boiling of the wort.

Our first experiment with an industrial stripping column filled with filler bodies, without plates that are difficult to clean, eliminated approximately 60 to 70% of the DMS, which is not sufficient to eliminate vigorous boiling of the wort.

We were therefore obliged to go against received wisdom in selecting a number of features required to obtain at least 85% elimination of DMS by stripping.

These features are as follows:

1—choosing a vertical column with a downward flow of the wort and an upward flow of steam;

2—separating the steam flow means and the wort flow means on the top plate, which tends to reduce the time of contact between the wort and the steam in the column;

3—distributing the flow of wort and the flow of steam regularly and uniformly across all of the cross-section of the column, which reduces the speeds, also reduces the periods of time of contact and consequently the exchanges of volatile material between the wort and the steam and increases the risk of insoluble materials in suspension in the wort settling out;

4—using wort distributor means in the form of orifices through the top plate, the number and the diameter of these orifices being predetermined to allow a predetermined flowrate of wort, given a predetermined depth of wort on top of the plate, whilst preventing the flow of steam;

5—using for the flow of steam chimneys of a predetermined height sufficient to prevent any overflow of the wort or of foam into the chimneys, which mobilises a predetermined height of the column;

6—using a filler body of relatively large size, and therefore of relatively low exchange surface area per unit volume, which reduces wort/steam exchanges, for example rings having a diameter of at least 3 to 4 cm;

7—using a plate to support the filler bodies having orifices with a total area equivalent to 90 or 100% of the cross-section area of the column, which minimises wort/steam contact;

8—distributing the steam inlet holes regularly across all of the cross-section of the column, which reduces any horizontal component of the steam flow facilitating wort/steam contact;

9—eliminating the racks which conventionally contain the filler bodies and which enable the filler bodies to be removed from a column very quickly to clean them and the interior of the column. This makes emptying the column a lengthy and labour-intensive process, and therefore one to be used only under exceptional circumstances This means that the operation of the column depends entirely on the effectiveness of cleaning the filler bodies inside the column, although as mentioned above the wort is an unstable suspension from which material may settle out.

In an entirely surprising manner, we have reliably obtained around 85% elimination of DMS at a wort flowrate in the order of 40 m³/h and a steam flowrate in the order of 0.5 to 1.5% by weight of the wort flowrate.

Most of the features mentioned above facilitate the cleaning of the interior of the stripping column, with the result that the column operates extremely reliably even though the hot wort constitutes a liquid suspension that must be handled with great care. The in situ cleaning of the interior of the column may be carried out sufficiently effectively to render emptying of the column to extract the filler bodies from it of zero utility and highly improbable.

A first object of the present invention is therefore to provide a desorption device for eliminating unwanted volatile components from beer wort.

A second object of the present invention is to provide a method of eliminating unwanted volatile components from beer wort using little evaporation.

A third object of the present invention concerns the use of a device for eliminating unwanted volatile components from beer wort.

The device for eliminating unwanted volatile components from beer wort comprises a column comprising:

means for uniformly distributing the beer wort inside said column in a first direction,

means for uniformly distributing a current of inert gas or steam inside the column in a second direction, preferably opposite to said first direction,

means for increasing the surface area of contact of said wort inside said column with said current of inert gas or steam.

In accordance with the invention, said means for uniform distribution of the wort comprise a distribution plate, the plane passing through said distribution plate being substantially perpendicular to the longitudinal axis of the column, said distribution plate being disposed at the same level as the wort feed of the column, preferably in the top part of said column, said distribution plate including first means for uniform flow of the wort in said first direction and second means for flow of said current of inert gas or steam in said second direction.

The number, the dimensions and the arrangement of the orifices on the distribution plate are not critical in themselves and must merely be such as to allow uniform flow of the wort through the distribution plate, in particular in accordance with the wort flowrate used in industry.

The orifices are preferably designed and disposed so that the wort entering the column does not pass through the distribution plate immediately, but remains on top of the distribution plate for a few seconds before flowing through the orifices.

In this way, a (preferably substantially constant) volume of wort remains on top of the distribution plate throughout the treatment, in order to compensate for variations in the flowrate of the wort entering the column and further to improve the uniformity of the distribution of the wort within the column.

The volume of wort remaining on top of the distribution plate is not critical in itself and depends n particular on the dimensions of the column and the flowrates chosen for treating the wort.

In a preferred embodiment of the present invention the second means for the flow of the current of inert gas or steam consist in chimneys disposed on the surface of the distribution plate.

The height of the chimneys is advantageously chosen so that the wort entering the column remains on top of the distribution plate before flowing uniformly through the orifices in the distribution plate, without passing through the chimneys. Direct passage of the wort through the chimneys generally causes foaming which is prejudicial to the efficiency of the column and must therefore be avoided.

The person skilled in the art will choose chimney dimensions and a wort flowrate such that the depth of the volume of wort remaining on top of the distribution plate is at all times less than the height of the chimneys and thereby prevent any wort passing through the chimneys.

In accordance with the invention, the volatile components are eliminated from the wort by transfer between the liquid phase of the wort and the gas phase of the current of inert gas or steam. In accordance with the invention, the efficiency of this transfer is improved by increasing the surface area of contact between the wort and the current of inert gas or steam.

The surface area of contact is advantageously increased by using rings located under said means for uniform distribution of the wort.

Rings of this type that can be used in the context of the present invention include Cascade® Mini Rings sold by Glitsch Inc., U.S.A.

The rings are advantageously disposed on a bottom plate substantially perpendicular to the longitudinal axis of the column and are randomly disposed on the plate, forming a diffuse array of stacked rings.

The wort flowing over the rings consequently follows a more or less random path from one ring to the other, for example by gravity alone, and the volatile components are transferred progressively into the current of inert gas or steam which preferably flows in the opposite direction.

It goes without saying that any other food grade system known in itself and increasing the surface area of contact may be used in place of the rings mentioned above. Non-limiting examples of products that can be used in the context of the present invention are random structure products such as the Pall Rings, Raschig Rings, Bearl Saddles sold by Glitsch Inc., U.S.A., organised structure products such as the Gempak® products sold by Glitsch Inc., U.S.A., etc.

In a preferred embodiment of the present invention the bottom plate also has means for increasing the surface area of contact and which reduce the resistance to the flow of the current of inert gas or steam.

In a first embodiment of the invention the bottom plate has orifices in it and is corrugated over at least part of its surface. The orifices and the corrugations preferably provide a free surface area of between approximately 90% and approximately 100% of the cross-section area of the column.

In a second embodiment of the invention the bottom plate is a corrugated grid.

In accordance with the invention, the current of inert gas or steam is fed uniformly into the interior of the column from the region for extraction of the treated wort, which is preferably in the bottom part of the column.

The means for uniform distribution of the current of inert gas or steam advantageously comprise a main pipe, possibly communicating with secondary pipes, including a plurality of orifices regularly arranged over the major part of the main pipe and the secondary pipes to enable the current of inert gas or steam to be fed to the interior of the column over practically all the cross-section of the column. The means for uniform distribution of a current of inert gas or steam are advantageously at the same level as the region for extraction of the treated wort, which is preferably in the bottom part of the column.

The orifices are advantageously directed towards the bottom of the column, to prevent the wort entering the pipe or pipes.

In a preferred embodiment the device of the invention comprises means for extraction and/or recovery of the current of inert gas or steam.

In a first embodiment of the invention the top part of the column is provided with one or more valves for releasing the current of inert gas or steam to the exterior.

In another preferred embodiment of the present invention the current of inert gas or steam is recovered using any system known in itself, for example one or more condensers if steam is used, connected to the top part of the column by pipe means.

The size and the dimensions of the column and its various component parts are not critical in themselves and may be chosen to suit the production site, the volumes of wort to be treated and the required efficiency of elimination of unwanted volatile components, for example.

However, the arrangement of the various components within the column should be such that the distances between, for example, the outlet of the wort feed pipe and the wort distribution plate, between the wort distribution plate and the diffuse array of rings, and between the bottom plate and a wort recovery system, are not too great, to prevent the formation of foam that could compromise the optimum efficiency of the device of the invention.

The above distances are preferably not greater than approximately 0.5 m.

In a preferred embodiment of the present invention means are provided for cleaning the interior of the column after a plurality of treatment cycles, without demounting the column. The device of the invention has numerous inlets and outlets and cleaning merely by introducing a cleaning liquid into the device so that it follows the normal path of the wort is not always sufficient. Additional cleaning means are therefore provided.

The additional cleaning means advantageously comprise one or more distributors of washing or rinsing liquid located in various regions of the column.

Distributors of this kind may be provided at the level of the wort distribution means, at the level of the means for increasing the surface area of contact of the wort with a current of inert gas or steam, at the level of the means of distribution of the current of inert gas or steam, at the level of the means for recovering the treated wort, for example.

The distributors are, for example, products known as “cleaning balls” enabling a particular area to be covered with a washing or rinsing liquid, for example water or soda solution, fed in through a pipe.

The cleaning balls usable in the context of the present invention are, for example, the “spray cleaning devices” sold by the German company Tuchenhagen.

The distributors are advantageously connected to external command and control systems known in themselves.

The various components of the device of the oresent invention and the operations that they perform are advantageously commanded, regulated and controlled by a system that is preferably an external system.

For example, the wort feed pipe entering the column includes detector means, for example an infrared sensor, detecting water-wort transitions. The wort feed pump is also controlled by one or more regulator valves. The various valves used in the device of the invention include solenoid valves and/or pneumatic valves.

The inlet and the outlet of the heating system are also connected to temperature sensors, a safety valve at the outlet of the system enabling evacuation of the heat if necessary.

The extraction of the heated wort is regulated by an outlet pump. The outlet pump is preferably set to the same flowrate as the wort feed pump to maintain a constant level of wort in the lower part of the column, forming a wort buffer.

The device of the invention advantageously also comprises systems for detecting when the column is empty and the level of wort in the column, systems for measuring the level of the wort buffer in the bottom of the column, systems for measuring pressure differences when filling the column, and various safety valves, in particular valves venting to atmosphere to prevent underpressures and overpressures during filling and cleaning.

The various command, regulation and/or control systems are connected to electronic and/or computer control means known in themselves.

The device of the invention operates equally well at atmospheric pressure, at an increased pressure and at a slightly reduced pressure.

The invention also consists in a method of eliminating volatile components from beer wort.

In the method of eliminating volatile components from beer wort without significant evaporation, comprising a first stage of boiling the wort at a temperature varying between approximately 90° C. and approximately 150° C., followed by a second stage of separating unwanted volatile components from the wort, the second separation step is carried out in a device as described above.

In accordance with the invention, the method of the invention of eliminating volatile components operates equally well at atmospheric pressure as at a reduced pressure or an increased pressure.

In a first embodiment of the method, the pressure inside the column is slightly reduced, for example by a vacuum pump. In this case, the temperature of the boiling wort entering the column may be lower than the boiling point of the wort at atmospheric pressure. The boiling point differs according to the pressure, and appropriate adjustment of the pressure inside the column to reduce the pressure enables elimination of volatile components from the wort at a wort entry temperature lower than the boiling point at atmospheric pressure.

In this way preheating of the incoming wort may be dispensed with.

On the other hand, if the incoming wort is at a temperature higher than its boiling point at atmospheric pressure, it is possible to adjust the pressure inside the column to obtain an increase in pressure corresponding to the pressure at the temperature of the incoming wort and therefore to eliminate all the volatile components without it being necessary to cool the incoming wort.

The invention also consists in the use of a device as described above to eliminate unwanted volatile components from beer wort.

Additional advantages and features of the present invention will emerge from the following more detailed description of one embodiment of the invention given by way of non-limiting and purely illustrative example and the accompanying figures that relate to it and in which:

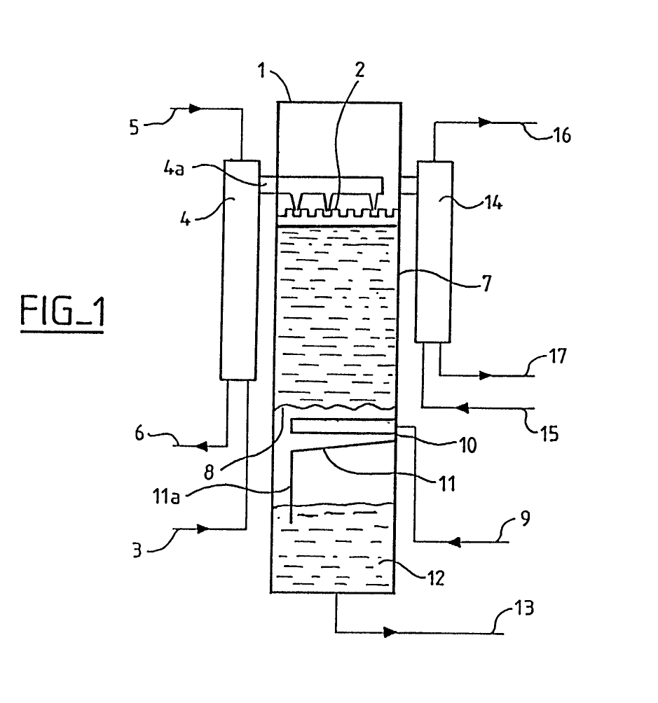

FIG. 1 is a diagram showing one embodiment of the device of the invention for elimination of volatile components;

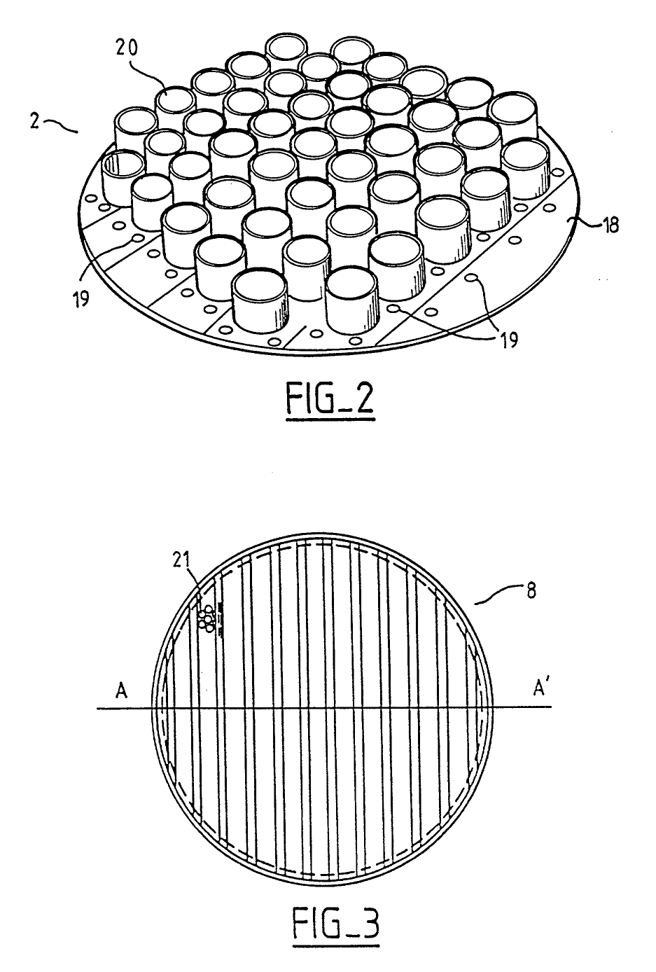

FIG. 2 is a diagrammatic front perspective view of one embodiment of the wort distribution plate;

FIG. 3 is a diagrammatic top view of one embodiment of the bottom plate;

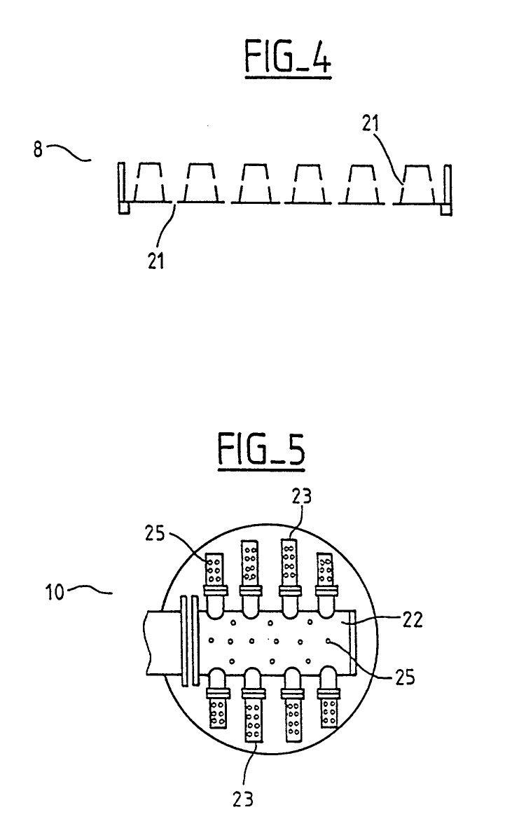

FIG. 4 is a diagrammatic view of the bottom plate from FIG. 3 in cross-section on the line A-A′; and

FIG. 5 is a diagrammatic bottom view of one embodiment of the system for distributing the current of inert gas or steam.

In the figures, the same reference numbers correspond to the same components.

Referring now to FIG. 1, in which the arrows show the various directions of flow of the fluids or gases used, the device for eliminating volatile components from beer wort includes a desorption column 1 having at the top a system 2 for uniform distribution of the wort.

The column 1 is fed through a pipe 3. Before reaching the column 1, the wort may be passed through a heating system 4. The heating system 4 is of a type known in itself and operates conventionally to increase the temperature of the wort by exchange of heat with steam arriving via the pipe 5, the condensate being extracted via the pipe 6.

The heated wort passes through the pipe 4a into the column 1 in a uniform manner because of the wort distributor 2. The wort then flows due to its weight alone through the interior of the filling region 7 of the column 1. Piled up rings (not shown in the figure) in the region 7 increase the surface area of contact between the wort and the current of inert gas or steam. The rings rest on a bottom plate 8 described in more detail below.

Steam or an inert gas such as nitrogen is fed from the pipe 9 into the interior of the column 1 through a uniform distribution system 10.

In the FIG. 1 preferred embodiment the beer wort is distributed downwards and the current of inert gas or steam is distributed upwards.

At the end of its path through the filling region 7, the wort falls onto a collector system having an inclined surface 11 from which the wort flows across a baffle 11a into the bottom part 12 of the column 1, corresponding to the bottom of said column, without any significant quantity of foam being formed. Instead of the single inclined surface 11 described above, a plurality of inclined surfaces may be provided, the respective baffles of the various inclined surfaces guiding the flow of treated wort into a common area. The collected wort, from which the volatile components have been removed, forms a buffer area in the bottom of the column that is then extracted via the pipe 13 to cooling and/or fermentation tanks.

It goes without saying that the inclined surface 11 constitutes only one preferred embodiment of the system for collecting the treated wort. Any other system avoiding the significant formation of foam may be used in place of the inclined surface 11.

A condenser 14 is provided to recover the steam used to treat the wort and the eliminated volatile components. The condenser 14 receives cooling water, for example well water, via the pipe 15. After flowing through the condenser 14, the cooling water is extracted via the pipe 16 and the condensate containing the volatile components is extracted via the pipe 17 to a drain or to any other device for storage or subsequent treatment.

Referring now to FIG. 2, the plate 2 for uniform distribution of the wort is seen to comprise a metal base 18 with orifices 19 and chimneys 20 regularly arranged on its surface.

The number and the dimensions of the orifices and the wort flowrate are chosen so that a particular and substantially constant volume of wort remains on top of the base 18 throughout the treatment, the height of the chimneys 20 being such as to prevent the volume of wort remaining on the base 18 passing through the chimneys 20.

FIGS. 3 and 4 show one embodiment of the bottom plate 8. The bottom plate 8 is a corrugated plate with orifices 21 in it through which the filling region communicates with the bottom of the column. FIG. 3 shows only some of the orifices 21, but it is to be understood that there are orifices 21 over all of the surface of the bottom plate 8.

Referring now to FIG. 5, it is seen that the uniform distributor 10 for the current of inert gas or steam comprises a main pipe 22 communicating with a plurality of secondary pipes 23. The bottom faces of the pipes 22 and 23 incorporate orifices 25 enabling uniform distribution of the steam or the inert gas inside the column. The inert gas or steam is therefore initially expelled towards the bottom of the column, afterwards rising towards the top part of the column.

The flowrate of the steam or inert gas is preferably approximately 0.5% to approximately 3% by weight of the flowrate of the wort.

One example of the elimination of unwanted volatile components from beer wort is given below.

### EXAMPLE

A desoriotion column 0.95 m in diameter and 2.20 m high was preheated to prevent condensation at the start of treatment and also to enable the real internal temperature inside the column to be measured. For this purpose water at a temperature of 70-85° C. was fed into the column and heated to 90° C. for five minutes.

Steam at a flowrate of 900 kg/h was then injected into the column for five minutes and the surplus steam was condensed by the condenser fed with cold water.

The measured internal pressure corresponds to atmospheric pressure and is used to evaluate the boiling point that the wort to be treated must have on entering the column.

Before the wort was introduced into it, the column was emptied to prevent dilution of the wort during starting up of the treatment.

A sample of 420 hl of Pils type beer wort was then fed into the column at a flowrate of 400 hl/h. The wort entering the column was preheated to the temperature determined according to the internal pressure of the column, namely 100.5° C. Steam at a temperature of 100° C. at atmospheric pressure was fed into the column, at a flowrate of 600 kg/h, corresponding to 1.5% by weight of steam relative to wort.

The treatment was continued and the bottom of the column progressively filled with the buffer of treated wort. An outlet pump was started, with the flowrate adjusted so that the level of the treated wort buffer remained constant, at a depth of 0.3 m.

The effectiveness of the treatment to eliminate volatile components was verified in the following manner.

The DMS (dimethyl sulphide) content of the beer wort to be treated was analysed by gas phase chromatography before commencing feeding it into the column. The wort leaving the column was analysed in the same way and the DMS content was compared to the initial DMS content.

The analysis of the sample showed that the DMS content before entry into the device of the invention was 200 to 300 parts per billion (ppb). The sample leaving the column had a DMS content of 30 to 45 ppb, corresponding to an elimination of approximately 85% by weight of the volatile components.

This low content leads to a final product in which the DMS content is less than the value of 50 ppb regarded as the acceptable value in the brewing industry.

Analysing the DMS content of the condensate collected confirmed that the quantity of DMS absent from the wort leaving the column corresponded to that found in the condensates, showing that the device of the invention was responsible for the elimination of the volatile components.

If 85% elimination of DMS is insufficient, given the proportion of DMS in the wort entering the stripping column, it is a simple matter to briefly and vigorously boil the wort before it enters the column, for example for 5 to 10 minutes, to reduce the proportion of DMS on entering the column.

The elimination of DMS can be very significantly increased, for example to at least 90% or 95%, by significantly increasing the height and the diameter of the stripping column.

It goes without saying that the present invention is not limited to the embodiments that have just been described, but to the contrary encompasses all variant executions thereof.

The person skilled in the art will be able to adapt the present invention to their own requirements by simple adjustments that do not depart from the scope of the present invention as defined in the accompanying claims.

1. Device for eliminating unwanted volatile components from beer wort, comprising a column (1) comprising:
means (2) for uniformly distributing the beer wort inside said column (1) in a first direction,
means (10) for uniformly distributing a current of inert gas or steam inside the column (1) in a second direction, preferably opposite to said first direction, and
means for increasing the surface area of contact of said wort inside said column (1) with said current of inert gas or steam.

2. Device according to claim 1 wherein said means for uniform distribution of the wort comprise a distribution plate (2), the plane passing through said distribution plate (2) being substantially perpendicular to the longitudinal axis of the column (1), said distribution plate (2) being disposed at the same level as the wort feed of the column (1), which is preferably in the top part of said column, said distribution plate (2) including first means for uniform flow of the wort in said first direction and second means for flow of said current of inert gas or steam in said second direction.

3. Device according to claim 2 wherein the first means for uniform flow of the wort comprise a plurality of orifices (19) in said distribution plate (2).

4. Device according to claim 2 wherein the second means for flow of said current of inert gas or steam comprise a plurality of chimneys (20) on the surface of said distribution plate (2).

5. Device according to claim 4 wherein the chimneys (20) have a height sufficient to prevent the wort on top of said distribution plate (2) flowing through said chimneys (20) when the column (1) is operating.

6. Device according to claim 1 wherein said means for increasing the surface area of contact of the wort with a current of inert gas or steam comprise a plurality of rings disposed randomly on a bottom plate (8) and forming a diffuse array of stacked rings, said diffuse array being located under said means (2) for uniform distribution of the wort.

7. Device according to claim 6 wherein the plane passing through the bottom plate (8) is substantially perpendicular to the longitudinal axis of the column (1) and said bottom plate (8) has means for increasing the surface area of contact, said means being additionally adapted to reduce the resistance to the flow of said current of inert gas or steam.

8. Device according to claim 7 wherein the bottom plate (8) has corrugations over at least part of its surface and a plurality of orifices (21) arranged on its surface.

9. Device according to claim 6 or claim 7 wherein the bottom plate (8) is a corrugated grid.

10. Device according to claim 1 characterised in that the means (10) for uniform distribution of a current of inert gas or steam comprise a main pipe (22), optionally communicating with secondary pipes (23), disposed at the level of the region from which the treated wort is extracted, which is preferably in the bottom part of the column (1), and having a plurality of orifices (25) regularly arranged on the greater part of the main pipe (22) and the secondary pipes (23) so that the current of inert gas or steam can be fed into the interior of the column (1) over substantially all of the cross-section of said column (1).

11. Device according to claim 10 wherein the orifices (25) are directed towards the bottom of the column (1).

12. Device according to claim 1 comprising means for collecting the treated wort without significant formation of foam.

13. Device according to claim 12 characterised in that the means for recovering the treated wort comprise at least one preferably inclined surface (11) directed towards the bottom of the column (1) and in the bottom part of said column (1), said surface (11) having means (11a) forming a baffle directed towards the bottom of said column (1).

14. Device according to any one of claims 1 to 13 wherein the first direction in which the wort is distributed is downwards and the second direction in which the current of inert gas or steam is distributed is upwards.

15. Device according to any one of claims 1 to 14 further comprising additional means for cleaning the interior of the column (1).

16. Device according to claim 15 wherein the cleaning means comprise a plurality of distributors of washing or rinsing liquid located at the level of the means (2) for distribution of the wort, at the level of the means for increasing the surface area of contact of the wort with said current of inert gas or steam, at the level of the means (10) for distributing a current of inert gas or steam, at the level of the means (11, 11a) for collecting the treated wort, said distributors being connected to external command and control means.

17. Device according to any one of claims 1 to 16 further comprising a system (4) for heating the wort before it enters the column (1), said heating system (4) being connected to the column (1) by pipe means (4a).

18. Device according to any one of claims 1 to 17 further comprising means for extracting the current of inert gas or steam.

19. Device according to claim 18 wherein the extractor means comprise one or more valves in the top part of the column (1) and releasing the inert gas or the steam to the exterior of the column (1).

20. Device according to any one of claims 1 to 17 further comprising means for recovering the current of inert gas or steam and the condensates.

21. Device according to claim 20 wherein the means for recovering the current of steam and condensates comprise one or more condensers (14) connected to the top part of the column (1) by pipe means.

22. Device according to any one of claims 1 to 21 further comprising means for regulating and/or controlling the flowrate of the wort entering the column (1).

23. Device according to any one of claims 1 to 21 further comprising means for regulating and/or controlling the flowrate of the current of inert gas or steam into the column (1).

24. Device according to claim 22 or claim 23 wherein the regulation and/or control means comprise solenoid valves and/or pneumatic valves.

25. Method of eliminating unwanted volatile components from beer wort, without significant evaporation, comprising a first step of boiling the wort at a temperature varying between approximately 90° C. and approximately 150° C., followed by a second step of separating unwanted volatile components from said wort carried out in a device as claimed in any one of claims 1 to 24.

26. Method according to claim 25 wherein the internal pressure in the column is controlled in accordance with the temperature of the wort entering the column.

27. Use for the elimination of unwanted volatile components from beer wort of a device as claimed in any one of claims 1 to 24.
